(19) United States
(12) Patent Application Publication
(10) Pub. No.: US 2014/0258835 A1
(43) Pub. Date: Sep. 11, 2014

(54) SYSTEM AND METHOD TO DOWNLOAD IMAGES FROM A WEBSITE

(71) Applicant: COREL CORPORATION, Ottawa (CA)

(72) Inventor: Stephen Wesley Mereu, Carp (CA)

(73) Assignee: Corel Corporation, Ottawa (CA)

(21) Appl. No.: 13/793,814

(22) Filed: Mar. 11, 2013

(51) Int. Cl. G06F 17/22

(52) U.S. Cl. CPC G06F 17/2247
USPC 715/234

(57) ABSTRACT

A method includes the steps of: providing a computer readable non-transitory storage medium including a computer readable code configured to run on a computer and to perform a process to locate and download one or more images from a webpage based on a source code of the webpage; selecting the webpage by entering a webpage address; downloading by computer the source code of the webpage at the webpage address; searching by computer the source code for one or more image elements related to the one or more images; parsing by computer the one or more image elements for image attributes; and displaying by computer the one or more images in an image user interface (IUI). A system to perform the method is also described.

### FIELD OF THE INVENTION

The invention relates to a system and method to locate images at a website and more particularly to a system and method to identify and download images from a website webpage.

### BACKGROUND OF THE INVENTION

There is a proliferation of cameras of all types from point and shoot cameras and cell phone cameras to all types of dedicated digital cameras. Additionally, there are computer programs which can create images. Images abound across the Internet, and a website without an image is a rare exception. With literally billions of images publically available, with proper legal permissions and/or situations, users around the world can reuse or apply in new applications, images made available by millions of other users of the Internet.

One problem with transferring images from an Internet source, such as for example, transferring an image from a webpage on the Internet, is that such images generally need to be copied one image at a time. Another problem is that on occasion, images of interest which are publically available in the source code of a published webpage sometimes do not appear visible on the corresponding page displayed by an Internet browser.

### SUMMARY OF THE INVENTION

There is a need for a system and method to more efficiently obtain image files from websites.

According to one aspect, the invention features a method which includes the steps of: providing a computer readable non-transitory storage medium including a computer readable code configured to run on a computer and to perform a process to locate and download one or more images from a webpage based on a source code of the webpage; selecting the webpage by entering a webpage address; downloading by computer the source code of the webpage at the webpage address; searching by computer the source code for one or more image elements related to the one or more images; parsing by computer the one or more image elements for image attributes; and displaying by computer the one or more images in an image user interface (IUI).

In one embodiment, the IUI includes a tray of a computer graphics program or a computer drawing program.

In another embodiment, the method further includes the step of selecting at least one of the one or more images from the IUI and adding the at least one of the one or more images to a computer drawing.

In yet another embodiment, the step of parsing the one or more image elements includes parsing the one or more image elements for one or more image attributes selected from the group consisting of URL, image description, image title, and size of image.

In yet another embodiment, the step of displaying the one or more images includes displaying the one or more images with a title derived from at least one of the one or more image attributes.

In yet another embodiment, the method further includes a step of searching the source code for elements indicating one or more child pages and repeating the steps of downloading the source code and searching the source code of one or more of the child pages.

In yet another embodiment, the process scrapes images from a plurality of webpages beginning at a parent webpage address and continuing recursively to find images on one or more child webpages including child pages of the child pages.

In yet another embodiment, the parent webpage address includes a website root page or a website home page.

In yet another embodiment, the step of selecting the webpage includes selecting the webpage from within a file navigation system of an application program.

In yet another embodiment, the step of searching the source code includes searching the source code for one or more IMG elements.

In yet another embodiment, the step of searching the source code includes searching a hypertext mark-up language (HTML) source code.

In yet another embodiment, the step of retrieving one or more file locations includes retrieving one or more uniform resource locator (URL) file locations for the one or more images.

In yet another embodiment, the method further includes the step of downloading the one or more image files from one or more file locations to a file management system running on a local computer.

In yet another embodiment, the step of downloading the one or more image files further includes displaying the one or more image files as one or more low resolution image icons of the one or more images.

In yet another embodiment, following the step of downloading the one or more image files, the step of displaying the one or more low resolution image icons in a tray.

In yet another embodiment, the step of downloading the one or more image files further includes analyzing by computer based on an image file name an image content of the one or more images and downloading a subset of the one or more images based on the image content.

In yet another embodiment, the step of downloading the one or more image files further includes analyzing the one or more image files for an image content.

In yet another embodiment, the image content is determined by an image recognition process.

According to one aspect, the invention features a system which includes a local computer configured to run a computer readable non-transitory storage medium including a computer readable code configured to run on the computer and to perform a process to locate and download one or more image files from a webpage based on a source code of the webpage, the computer readable code configured to select the webpage by entering a webpage address, to download by computer the source code of the webpage at the webpage address, to search by computer the source code for one or more image elements related to the one or more images, to parse by computer the one or more image elements for image attributes, and to display by computer the one or more images in an image user interface (IUI).

In one embodiment, the computer readable code is further configured to recursively parse one or more child webpages.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 shows a block diagram of a system suitable for performing the processes described herein;

FIG. 2 shows a block diagram of one exemplary process to scrape a webpage for images;

FIG. 3 shows an exemplary image found using the source code of a webpage;

FIG. 4 shows a more detailed block diagram of one exemplary process operating on an HTML source code; and

FIG. 5 shows a block diagram of a process to scrape image files from a webpage.

### DETAILED DESCRIPTION

The images at a website are usually stored on a network connected computer server. The server is generally, but not necessarily, the same server as that which hosts the website. Images are often referenced by their own URL address in the webpage's source code. The webpage source code tells the browser how to render the webpage on a user's computer screen. The images are typically presented as digital picture files of some compatible file format that can be displayed by the browser. JPEG files (.jpg file types) are but one example of a file format commonly so used.

The source code of a webpage can be viewable by a tool option as text in most Internet browsers. Source listings of many types represent images by “IMG” tag in the source code. There can be other relevant image tags. However IMG is universally recognized as a tag which can notify a browser that nearby in the source code, a path to an image follows the tag. While the actual image file, such as a JPEG file might reside on a local drive, more likely it has been “pre-posted” at some uniform resource locator (URL) address. As is well understood by those skilled in the art, close inspection of the website source page code will reveal the actual address, such as, for example, a URL address where the image file of the displayed image can be found. A user desiring to copy the image as displayed by a browser, can obtain the actual image file from that URL. Alternatively, the user can use some built-in feature of the web browser to copy the image file. One such browser image copy method usually includes a mouse hover of the computer cursor over the image with a right-click menu and copy selection, a feature also well known to many browser users. The problem is that such image acquisition has to be done one image at a time. Also, on webpages that need to be scrolled across more than one screen height, or more than on screen width, images of interest which are off-screen might be missed. Yet another problem is that some images made publically available through the webpage source code, might not be actually displayed by the webpage.

It is understood that associated with each image of a website, there is some legal status of intellectual property. In the solution to the problem of efficiently copying image files from a website as described herein, it is understood that appropriate legal permissions may be needed to copy, reprint, or otherwise re-use such image files. The invention described herein does not address this legal issue, but rather only describes a technical solution to the problem of efficiently obtaining or “scraping” images that have been publically posted on a webpage of a website. It is understood that users of the invention may need to obtain legal permissions for some uses of any copied images, as an issue unrelated to the technical solution described herein. Thus, the invention describes a completely legal operation when so appropriately used.

There are file navigation computer programs, such as for example, Microsoft's Windows Explorer™ of the Windows™ operating system which can efficiently navigate files on a local computer. In the example of Windows Explorer™, if a user types the URL of a website into the file name bar, Windows Explorer™ has been programmed to open a Web browser such as Internet Explorer™ which then, assuming a valid URL and displayable webpage at that URL, displays a webpage by opening a separate web browser program. Increasingly computer application programs also offer some file navigation capabilities. Some of these computer program file navigation capabilities have become quite complex, additionally offering, for example, integration of located files into a file management system tailored to the application. One such exemplary file management system is the tray system of Corel CONNECT™ available from the Corel Corporation of Ottawa, Canada, where images available to the program are display in trays as small icon representations of the images. Other programs of the Corel graphics suite, such as for example, CorelDRAW, can directly access images in a CONNECT™ tray.

A dedicated file system of an application program can also be configured to access webpages directly. However, once navigated to a webpage, prior art methods only provide for copying image files one at a time using a web browser. Also, references to images publically published in the webpage source code, but not presently actively displayed on the page are not immediately available for selection by visual means.

It was realized that an efficient process to “scrape a webpage” of all publically available image files can work as follows: 1) Navigate to the URL of the webpage of interest; 2) download the page source code; 3) search the page source code by computer for instances of an image (e.g. by searching for an “IMG” tag); 4) navigate by computer to each of the instances of a code reference to an image file (e.g. by checking the code at each instance of an IMG tag for an associated image file URL) and download one or more of the downloadable images found (preferably scraping all of the image files that can be so downloaded for a given webpage). Once the process has downloaded the images from the webpage, a list of the downloaded images can be displayed by a file name, or as icons representing the actual downloaded pages in the local application program file management system. The CONNECT™ computer application program available from the Corel Corporation of Ottawa, Canada uses such a process to scrape a webpage and to deliver all of the publically available images from the webpage. CONNECT™ can further send the scraped images to a CONNECT Tray™, where the images can be displayed as small icons of the downloaded images and shared amongst other graphics application programs of a suite of computer graphics programs.

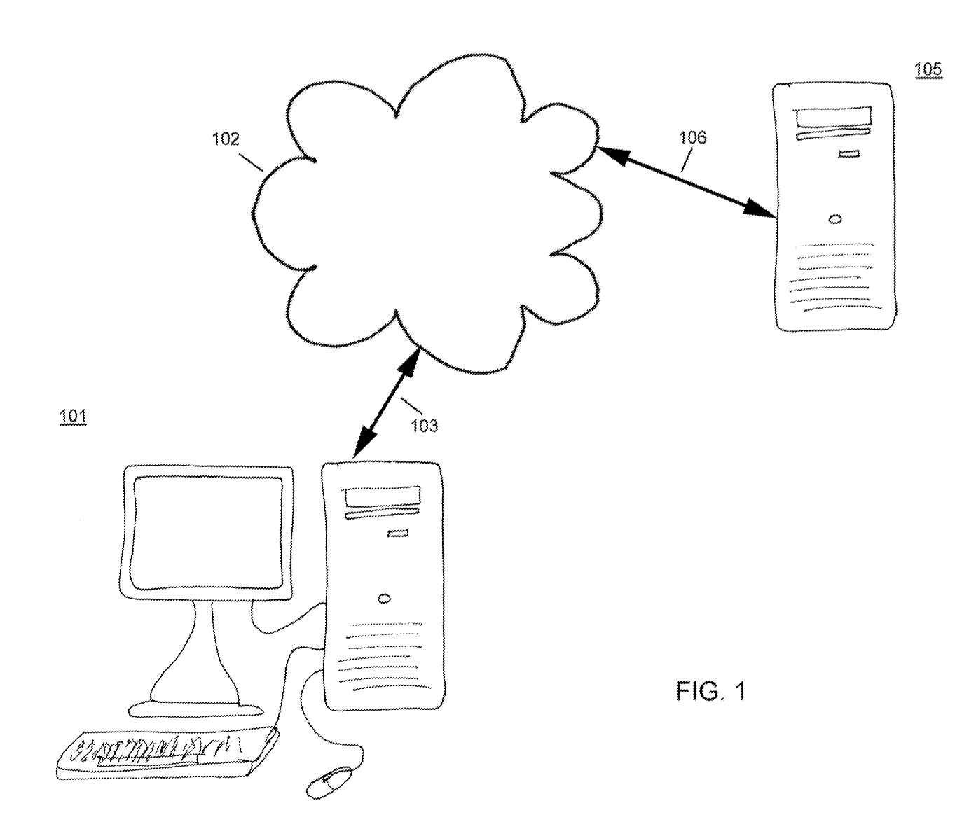

FIG. 1 shows a block diagram of one exemplary computer system suitable for performing the processes described herein. A computer, typically a local computer 101 (e.g. a client computer) is connected via any suitable data connection 103 (e.g. Cable modem, WiFi, WiMAX, FioS, DSL, local or wide area Ethernet network connections, etc.) typically via an Internet connection, to any suitable cloud 102 (typically an intranet or the Internet). A computer server 105 which hosts one or more websites having one or more webpages is also connected to the cloud 102 via any suitable connection 106. The computers, local computer 101, and server 105, need not be of the same type computer.

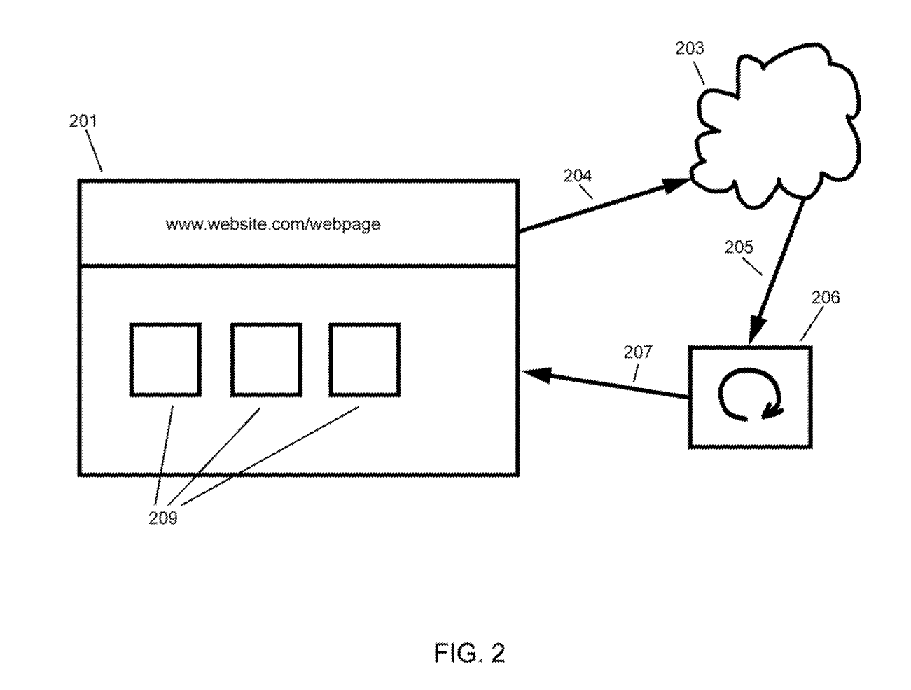

FIG. 2 shows a block diagram showing one exemplary process that can be used to scrape a webpage for images publically referenced in the webpage source code. As shown in FIG. 2, in one embodiment of the process, a URL of any webpage can be entered into a text entry field of the local file management graphical user interface 201 (GUI). It is contemplated that in other embodiments, a user interface (UI) could be displayed which could allow a user to select a page using a different entry or selection method. For example, one exemplary alternative to the text entry field described hereinabove could be to show a fixed and/or dynamic list of websites that the user can select from. Another alternative UI could allow the user to first perform a general search, where web pages returned by the general search that match some search criteria could then be listed (either by text, icon, or any other suitable listing) from which the user then makes a selection.

The file navigation application then navigates to the URL 204 of the webpage via any suitable network connection and downloads 205 the webpage source code. However, unlike a conventional browser of the prior art, the file application generally does not then render a webpage for browser style viewing according to the directions of the source code. Rather, the file application iteratively searches the alphanumeric characters of the source code for instances of an image reference, and in particular for instances of references to images, which instances in some recognizable way, point to a URL of the corresponding image file. Most commonly the reference is a hypertext mark-up language (HTML) image link. While many webpages are coded in HTML or include some HTML code, the processes described herein are believed to be generally applicable to any type of webpage source code and/or format. However, any usable image file location and/or reference to an otherwise downloadable item can suffice. Once the file application has identified available images and locations for their associated image files, the file application can proceed to download the image files. It is unimportant to the process whether the image files are acquired as they are found, or if the image files are downloaded as a second step, after the potentially downloadable image files have been found in the source code of the webpage. The FIG. 2 box 206 with the circle shaped line and arrow within, represents the iterative process of finding image files in the webpage source code and iteratively acquiring those available image files typically by downloading the image files and displaying the image files in a UI, such as for example, an image user interface (IUI) and/or copying them 207 to the local application file system. It is further contemplated that beyond the iterative process of finding image files in the webpage source code, the process could also recursively process any webpage referenced on a “parent” webpage (e.g. a website root or home page) to look for images on “child” webpages of that parent webpage.

The acquired images can be displayed, for example, as icon representations 209 (typically relatively low resolution versions of the images) of the acquired images. Or, the images can be displayed in their original resolution.

A UI such as, for example an IUI, displays only images and optionally related information, such as, for example, an image title, image URL, or other suitable image label. A UI as used herein (e.g. an IUI) differs from a web browser in that an IUI displays only images from one or more webpages of a website, optionally with some related image labeling information. An IUI does not display the webpage from which the images were scraped. On the other hand, a web browser, as instructed by the source code listing, conventionally displays a webpage. Typically, the browser formats the page, and displays both text and images according a format or style. By contrast, a UI or IUI of the process described herein ignores page formatting and style information beyond specific references to images, image files, and/or image URLs. Thus a UI (e.g. IUI) as described herein does not include conventional web browsers, such as for example, Internet Explorer™, Firefox™, Chrome™, etc., which render a web page as directed by the webpage source code including the web page text, web page styling and webpage images displayed at certain locations on the webpage according to formatting directions in the webpage source code. The Corel CONNECT Tray™ is an example of an IUI.

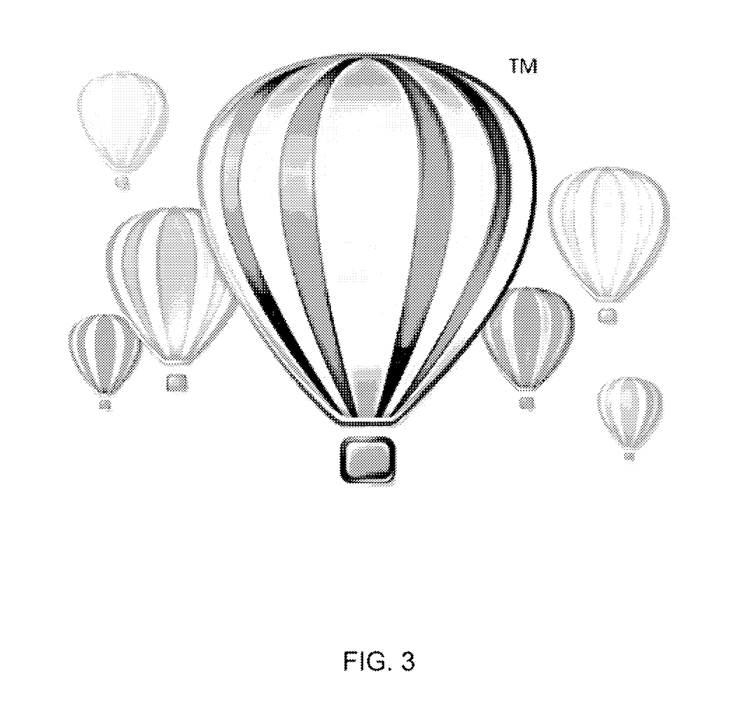

As described hereinabove, one or more of the images returned to the local computer may be images not presently visible on the webpage. For example, a scrape of a Corel Corporation webpage returned the image shown in FIG. 3, a black and white bit mapped representation of the downloaded image. The image of FIG. 3 was found and downloaded using the publically available reference in the webpage source code. However, this particular image was not presently being displayed on that webpage.

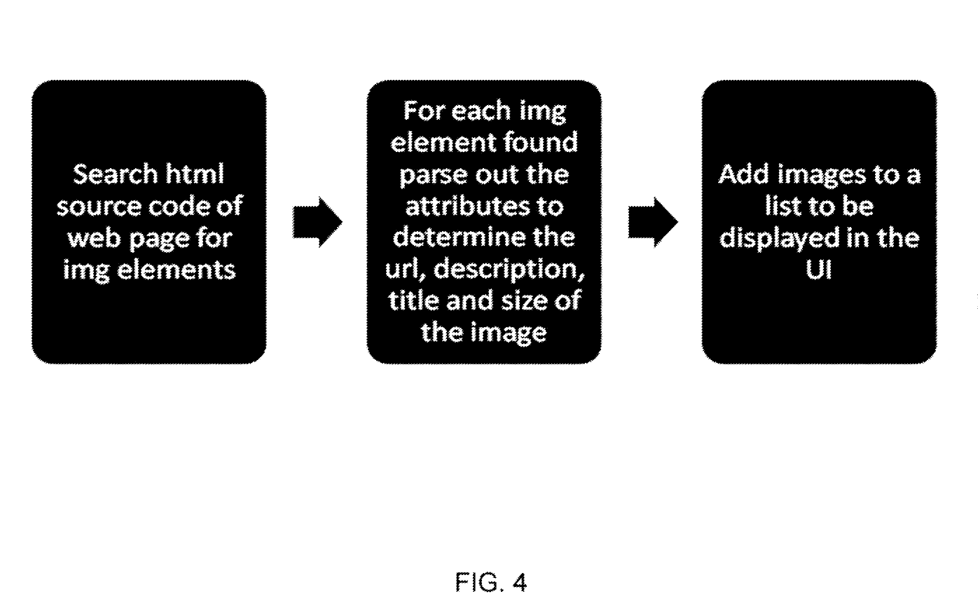

FIG. 4 shows a block diagram illustrating in more detail, one embodiment of the process. In the exemplary embodiment of FIG. 4, the process performs a regular expression search of the text for “<img.*?>” while ignoring case differences. This search produces a list of instances where the img tag has been used. The list of instances is then iterated to parse each result and to look for one or more of the following properties: alt, class or id attributes which can be used as a description of the image; the src or thumb attributes that can be used as the URL for the image; and the width and height attributes which can be used as the size of the image. The URL can be a full URL or can be relative to the webpage root address. The last part of the URL, which is typically a filename, can optionally be extracted and applied as a UI displayed image title. The process supports html img images. It is contemplated that the process can also include any other suitable kind of content and markup types.

The process can also be used to scan other pages of a website. For example, it is contemplated that the process can be used to recursively read child webpages referenced by a parent webpage. Further, child webpages of child webpages can also be automatically scraped of images. The progression from webpage to a next level of webpages can continue until no more webpages can be found, thus substantially scraping an entire website for publically available images. The process can be configured to start from a website root page and then recursively parse across one or more child webpages. It is believed that by such a recursive process, substantially all of the pages of a website can be visited to scrape substantially all of the images from a website.

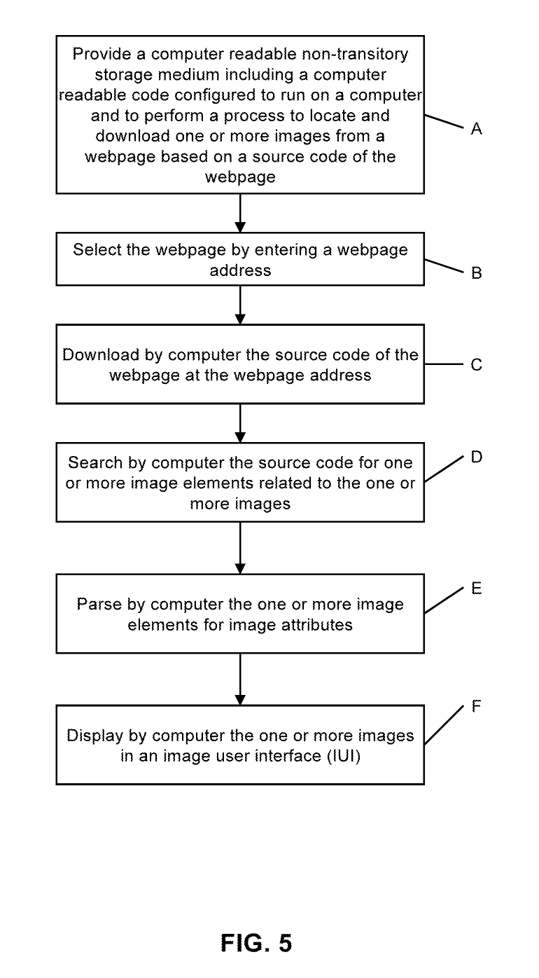

In summary, as shown by the block diagram of FIG. 5, a process to scrape image files from a webpage can proceed as follows: A) provide a computer readable non-transitory storage medium including a computer readable code configured to run on a computer and to perform a process to locate and download one or more images from a webpage based on a source code of the webpage; B) select the webpage by entering a webpage address; C) download by computer the source code of the webpage at the webpage address; D) search by computer the source code for one or more image elements related to the one or more images; E) parse by computer the one or more image elements for image attributes; and F) display by computer the one or more images in an image user interface (IUI). As described hereinabove, in some embodiments of the process, steps C to F can be repeated recursively to further scrape images from one or more additional pages of a website.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A method comprising the steps of:
providing a computer readable non-transitory storage medium comprising a computer readable code configured to run on a computer and to perform a process to locate and download one or more images from a webpage based on a source code of said webpage;
selecting said webpage by entering a webpage address;
downloading by computer said source code of said webpage at said webpage address;
searching by computer said source code for one or more image elements related to said one or more images;
parsing by computer said one or more image elements for image attributes; and
displaying by computer said one or more images in an image user interface (IUI).

2. The method of claim 1, wherein said IUI comprises a tray of a computer graphics program or a computer drawing program.

3. The method of claim 1, further comprising the step of selecting at least one of said one or more images from said IUI and adding said at least one of said one or more images to a computer drawing.

4. The method of claim 1, wherein said step of parsing said one or more image elements comprises parsing said one or more image elements for one or more image attributes selected from the group consisting of URL, image description, image title, and size of image.

5. The method of claim 4, wherein said step of displaying said one or more images comprises displaying said one or more images with a title derived from at least one of said one or more image attributes.

6. The method of claim 1, further comprising a step of searching said source code for elements indicating one or more child pages and repeating said steps of downloading said source code and searching said source code of one or more of said child pages.

7. The method of claim 6, wherein said process scrapes images from a plurality of webpages beginning at a parent webpage address and continuing recursively to find images on one or more child webpages including child pages of said child pages.

8. The method of claim 7, wherein said parent webpage address comprises a website root page or a website home page.

9. The method of claim 1, wherein said step of selecting said webpage comprises selecting said webpage from within a file navigation system of an application program.

10. The method of claim 1, wherein said step of searching said source code comprises searching said source code for one or more IMG elements.

11. The method of claim 1, wherein said step of searching said source code comprises searching a hypertext mark-up language (HTML) source code.

12. The method of claim 1, wherein said step of retrieving one or more file locations comprises retrieving one or more uniform resource locator (URL) file locations for said one or more images.

13. The method of claim 1, further comprising the step of downloading one or more image files from one or more file locations to a file management system running on a local computer.

14. The method of claim 13, wherein said step of downloading said one or more image files further comprises displaying said one or more image files as one or more low resolution image icons of said one or more images.

15. The method of claim 14, wherein following said step of downloading said one or more image files, the step of displaying said one or more low resolution image icons in a tray.

16. The method of claim 13, wherein said step of downloading said one or more image files further comprises analyzing by computer based on an image file name an image content of said one or more images and downloading a subset of said one or more images based on said image content.

17. The method of claim 13, wherein said step of downloading said one or more image files further comprises analyzing said one or more image files for an image content.

18. The method of claim 17, wherein said image content is determined by an image recognition process.

19. A system comprising:
a local computer configured to run a computer readable non-transitory storage medium comprising a computer readable code configured to run on said computer and to perform a process to locate and download one or more image files from a webpage based on a source code of said webpage, said computer readable code configured to select said webpage by entering a webpage address, to download by computer said source code of said webpage at said webpage address, to search by computer said source code for one or more image elements related to said one or more images, to parse by computer said one or more image elements for image attributes, and to display by computer said one or more images in an image user interface (IUI).

20. The system of claim 19, wherein said computer readable code is further configured to recursively parse one or more child webpages.
